(19) United States
(12) Patent Application Publication
(10) Pub. No.: US 2017/0168220 A1
(43) Pub. Date: Jun. 15, 2017

(54) BACKLIGHT MODULE AND LIGHT GUIDE PLATE THEREOF

(71) Applicants: Shenzhen China Star Optoelectronics Technology Co., Ltd, Shenzhen, Guangdong (CN); Wuhan China Star Optoelectronics Technology Co., Ltd., Wuhan, Hubei (CN)

(72) Inventor: Gege Zhou, Shenzhen, Guangdong (CN)

(73) Assignees: Shenzhen China Star Optoelectronics Technology Co., Ltd., Shenzhen, Guangdong (CN); Wuhan China Star Optoelectronics Technology Co., Ltd., Wuhan, Hubei (CN)

(21) Appl. No.: 14/778,254

(22) PCT Filed: Jun. 24, 2015
(86) PCT No.: PCT/CN2015/082187

§ 371 Date: Dec. 11, 2015

(30) Foreign Application Priority Data
Jun. 10, 2015 (CN) 201510315506.6

(51) Int. Cl. F21V 8/00

(52) U.S. Cl. CPC G02B 6/0036; G02B 6/0055; G02B 6/0093

(57) ABSTRACT

A light guide plate includes a plate-like body, a surface thereof being a light-emitting surface, and a projection extending from a surface of the body away from the light-emitting surface along a direction opposite to the light-emitting surface. The projection separates the body of the light guide plate from the reflecting sheet, so that an air layer is formed between the light guide plate and the reflecting sheet, thus rendering the body of the light guide plate and the reflecting sheet hardly attachable to each other. A backlight module comprises said light guide plate.

### CROSS REFERENCE TO RELATED APPLICATIONS

The present application claims the priority of Chinese patent application CN201510315506.6, entitled “Backlight module and light guide plate thereof” and filed on Jun. 10, 2015, the entirety of which is incorporated herein by reference.

### TECHNICAL FIELD

The present disclosure relates to the technology of liquid crystal display, and in particular, to a backlight module and light guide plate thereof.

### TECHNICAL BACKGROUND

Currently, a liquid crystal display device generally comprises a backlight module and a liquid crystal display screen (LCD screen) covering the backlight module. The backlight module serves as a light source for the LCD screen. The LCD screen modulates the light emitted by the backlight module, so that images and colors can be displayed thereon. With the development of liquid crystal display technologies, it is desired that backlight modules be higher in brightness, lower in power consumption, and better in optical quality.

FIG. 1 shows a conventionally edge-lit backlight module 1 comprising a light guide plate 2, a light bar 3, and a reflecting sheet 4. A left side of the light guide plate 2 is a light-incoming surface 5, and a top side of the light guide plate 2 is a light-emitting surface 7. The light bar 3 is arranged on the light-incoming side 5 of the light guide plate 2, and is provided thereon with light emitting diodes (LEDs) 6. The reflecting sheet 4 is arranged on a side of the light guide plate 2 opposite to the light-emitting surface 7, and covers the light guide plate 2. The reflecting sheet 4 comprises a reflecting surface facing the light guide plate 2. Light emitted by the LEDs 6 enters the light guide plate 2 through the light-incoming surface 5, and exits from the light-emitting surface 7 of the light guide plate 2 after one or multiple reflections in the light guide plate 2. Most of the light irradiating onto the reflecting surface from the light guide plate 2 is reflected back to the light guide plate 2, and then exits from the light-emitting surface 7, thereby improving the utilization of the light.

The reflecting sheet 4 and the light guide plate 2 easily attach to each other, i.e., the reflecting sheet 4 and the light guide plate 2 cling closely to each other. Usually, the reflecting sheet 4 comprises further a protecting layer provided on the reflecting surface. The protecting layer is made of a material with optical performances similar to a material for the light guide plate 2. For example, the speeds of light in these two materials are close to each other. When part of the reflecting sheet 4 attaches to the light guide plate 2, a larger critical angle of light irradiating onto the reflecting sheet 4 from the light guide plate 2 is formed, thereby causing, in the protecting layer, a wide-angle light leakage when light irradiates onto the reflecting sheet 4 from the light guide plate 2 via the attached part of the reflecting sheet 4 and the light guide plate 2. When viewing the light-emitting surface 7 along a direction of the light-emitting surface 7 perpendicular to the light guide plate 2, one will find that the attached part is darker than other parts, and that the light-emitting surface 7 is uneven in brightness, thereby rendering the optical quality of the backlight module 1 inferior.

### SUMMARY OF THE INVENTION

Directed by the technical problem of uneven brightness of the light-emitting surface of the light guide plate caused by easy attachment between the light guide plate and the reflecting sheet, the present disclosure provides a light guide plate. The light guide plate comprises a plate-like body, a surface thereof being a light-emitting surface, and a projection extending from a surface of the body away from the light-emitting surface along a direction opposite to the light-emitting surface.

In one embodiment, provided are two projections which are located close to two opposite sides of the body respectively.

In one embodiment, the two projections are the same in height.

In one embodiment, the projections are each in the shape of a strip, and extend parallel to side faces of the body which are close to the projections.

In one embodiment, the body has a side face for entering of light. The light guide plate is provided with two projections, one being close to the side face, and the other being opposite to the side face. Each projection is provided with a slope facing the other projection, and two slopes of the two projections are connected to form a arcuate surface depressed inwardly.

In one embodiment, the arcuate surface is formed by a translation movement of a circular arc or an elliptical arc along an extending direction of a straight line parallel to the sides and the light-emitting surface.

In one embodiment, the projections each have a top end in the shape of a cuspidal edge.

In one embodiment, the body has a side face for entering of light. The projections each are structured to be a prism extending in a direction parallel to the side face, and have a gradually narrower width along a direction opposite to the light-emitting surface.

In one embodiment, the projections each have a cross section of a triangle.

In one embodiment, the triangle is an isosceles right triangle with a base parallel to the light-emitting surface.

In one embodiment, the projections each are a right prism.

The present disclosure provides further a liquid crystal display device comprising said light guide plate.

The projection separates the body of the light guide plate from the reflecting sheet, so that an air layer is formed therebetween so as to ensure that the light guide plate and the reflecting sheet hardly attach to each other. In addition, the interface between the light guide plate and the air layer has homogeneous reflectivity, and critical angle of total reflection on the interface is small enough. Thus, the light coming out of the light guide plate through the light-emitting surface will be distributed more evenly.

### BRIEF DESCRIPTION OF THE DRAWINGS

A detailed description of the present disclosure will be given below based on the embodiments and with reference to the accompanying drawings.

FIG. 1 schematically shows a complete cross-sectional view of an existing backlight module;

FIG. 2 schematically shows a complete cross-sectional view of a backlight module according to embodiment 1 of the present disclosure;

FIG. 3 schematically shows a complete cross-sectional view of a backlight module according to embodiment 2 of the present disclosure;

FIG. 4 schematically shows a working state of the backlight module in FIG. 3; and

FIG. 5 schematically shows a complete cross-sectional view of a backlight module according to embodiment 3 of the present disclosure.

In the drawings, the same components are indicated with the same reference signs. The drawings are not drawn to scale.

### DETAILED DESCRIPTION OF THE EMBODIMENTS

The present disclosure will be explained further in detail with reference to the accompanying drawings.

### Embodiment 1

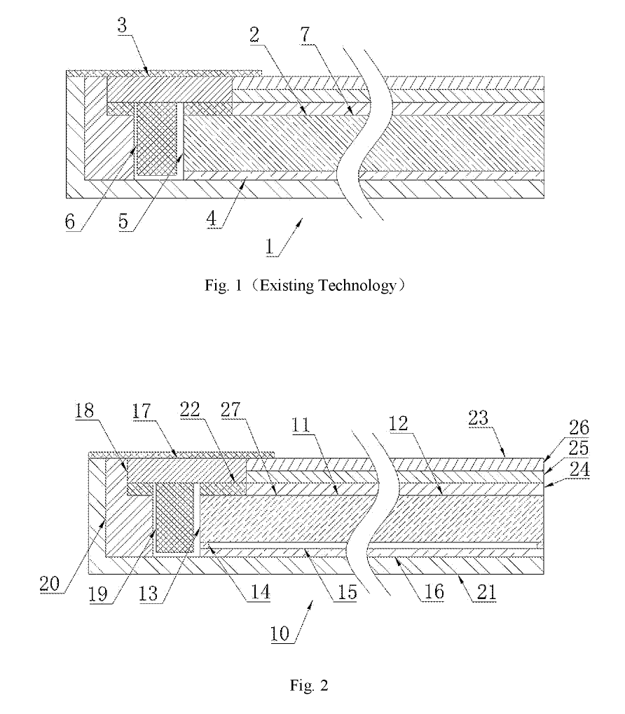

FIG. 2 schematically shows a structure of a backlight module 10 according to embodiment 1 of the present disclosure. The backlight module 10 comprises a light guide plate 11, a light bar 17, and a reflecting sheet 16.

The light guide plate 11 comprises a body 27 and a projection 14. The body 27 is in the shape of a roughly rectangular plate. A surface of the body 27 is a light-emitting surface 12. The surface of the body 27 opposite to the light-emitting surface 12 is a back surface. The projection 14 is arranged on a surface of the body 27 of the light guide plate 11 away from the light-emitting surface 12 (i.e., on the back surface of the body 27), and extends from the body 27 along a direction away from the light-emitting surface 12. An outer side face of the body 27 is a light-incoming surface 13.

The light guide plate 11 is usually made of a transparent material with a refractive index higher than that of air. The transparent material can be a transparent plastic, and is preferably polycarbonate, or polymethyl methacrylate.

The reflecting sheet 16 is in the shape of a flat, rectangular flake, and has a reflecting surface. The reflecting sheet 16 is arranged on the back surface of the light guide plate 11, with the reflecting surface facing the light guide plate 11. The reflecting sheet 16 abuts onto a top end of the projection 14 of the light guide plate 11. In this case, the projection 14 separates the body 27 of the light guide plate 11 from the reflecting sheet 16, so that an air layer 15 is formed between the body 27 and the reflecting sheet 16, thereby rendering the body of the light guide plate 11 and the reflecting 16 hardly attachable to each other.

The light bar 17 comprises a base plate 18 in the shape of roughly a strip, and a plurality of light-emitting elements 19 fixed on the base plate 18. The base plate 18 can be a flexible printed circuit board, and the light-emitting elements 19 can be light-emitting diodes (LEDs). The light-emitting elements 19 are spaced apart from one another, and are arranged uniformly on a same side of the base plate 18, along an extending direction of the base plate 18 and perpendicular to the base plate 18. The light-emitting elements 19 each have a luminous point on a side thereof, and these luminous points all face a same direction perpendicular to the extending direction of the base plate 18. The light bar 17 is fixed on the light guide plate 11, with the luminous points facing the light-incoming surface 13 of the light guide plate 11. For example, the side of the base plate 18 which is provided with the light-emitting elements 19 can be adhered to the light-emitting surface 12 of the light guide plate 11 with double-sided tape, with the luminous points of the light-emitting elements 19 facing the light-incoming surface 13 of the light guide plate 11.

With such arrangement, light emitted by the light-emitting elements 19 enters the light guide plate 11 through the light-incoming surface 13, and part of the light, after one or multiple reflections, exits from the light-emitting surface 12. An air layer 15 is formed between the body 27 of the light guide plate 11 and the reflecting sheet 16. The interface between the light guide plate 11 and the air layer 15 has homogeneous reflectivity, and the critical angle of total reflection on the interface is small enough. Besides, the body 27 of the light guide plate 11 and the reflecting sheet 16 can hardly attach to each other. Thus, the light coming out of the light guide plate 11 through the light-emitting surface 12 is distributed more evenly.

Preferably, the light guide plate 11 is very smooth on each side faces and the light-emitting surface 12, except the back surface which is provided with a plurality of etched/printed reflecting lattice points. The reflecting lattice points are densely distributed on the back surface, and are able to scatter the light irradiated thereon.

Part of the light, after one or multiple reflections in the light guide plate 11, is reflected onto the reflecting lattice points on the back surface of the light guide plate 11. Each of the reflecting lattice points can scatter the light irradiated thereon, causing part of the scattered light to irradiate on the light-emitting surface 12 with an incidence angle on the light-emitting surface 12 smaller than the critical angle. In this way, the part of the scattered light will come out of the light guide plate 11 through the light-emitting surface 12.

Preferably, two projections 14 are provided on the body of the light guide plate 11 on the surface away from the light-emitting surface 12. The two projections are located respectively close to two opposite side faces of the light guide plate 11, separating two opposite ends of the light guide plate 11 from the reflecting sheet 16. Thus, the body of the light guide plate 11 and the reflecting sheet 16 are completely separated from each other, and cannot attach together. Further preferably, two projections are the same in height. In this case, the light-emitting surface 12 of the light guide plate 11 is parallel to the reflecting surface of the reflecting sheet 16, and therefore the light passed through the light-emitting surface 12 of the light guide plate 11 is distributed more evenly. And particularly, there will be more light which exits from the light-emitting surface 12 of the light guide plate 11 and is perpendicular to the light-emitting surface 12, thereby rendering the front end of the light-emitting surface 12 of the light guide plate 11 more bright, and rendering a better display effect in the right front of the liquid display device.

Further preferably, the projections 14 are each in the shape of a strip, and extend in a direction parallel to the side faces close thereto. Thus, the two strip-like projections 14 can support the light guide plate 11 from two ends of the light guide plate 11, so as to increase area of the interfaces between the back surface of the body 27 and the air layer 15 while keeping a steady engagement between the light guide plate 11 and the reflecting sheet 16.

In the present embodiment, the projection 14 is in the shape of a rectangular frame. The four outer side faces of the frame of the projection 14 are aligned respectively with the four side faces of the light guide plate 11. The projection 14 abuts against edges of the reflecting sheet 16, and supports the reflecting sheet 16, preventing the reflecting sheet 16 from curling.

The backlight module 10 further comprises an optical diaphragm group 23, which is in a rectangular shape and covers the light-emitting surface 12. Preferably, a side of the optical diaphragm group 23 abuts onto a side of the base plate 18 of the light bar 17, while other three sides of the optical diaphragm group 23 are respectively aligned with three side faces of the light guide plate 11 (excluding the light-incoming surface 13). In one example, the optical diaphragm group 23 comprises diffusion sheet 24, lower prismatic lens 25, and upper prismatic lens 26 in sequence. The diffusion sheet 24 can be adhered to the light-emitting surface 12.

The backlight module 10 further comprises a frame 20 and a box-like back plate 21. The light guide plate 11, the reflecting sheet 16, and the light bar 17 are all arranged in the back plate 21. A side of the reflecting sheet opposite to the light guide plate 11 is fitted to a bottom side of the back plate 21. The frame 20 is in a rectangular shape, and is usually made from PC (i.e., polycarbonate) material. The frame 20 surrounds the light guide plate 11, the light bar 17, and the optical diaphragm group 23, and abuts by an outer circumference wall against the back plate 21. Such arrangement enables the light guide plate 11, the light bar 17, the frame 20, the reflecting sheet 16, the optical diaphragm group 23, and the back plate 21 to be secured relative to each other. The back plate 21, as a housing of the backlight module 10, protects the components provided therein. Besides, the back plate 21 is usually made of a rigid material, and as a framework, supports the backlight module 10. The frame 20 can also achieve a cushioning effect of protecting the light guide plate 11, the light bar 17, and the optical diaphragm group when an impact is exerted on the backlight module 10.

### Embodiment 2

The backlight module 30 in embodiment 2 differs from the backlight module 10 in embodiment 1 merely in structure of the light guide plate. For conciseness, the following description will focus mainly on the light guide plate 31 of the backlight module 30 in embodiment 2.

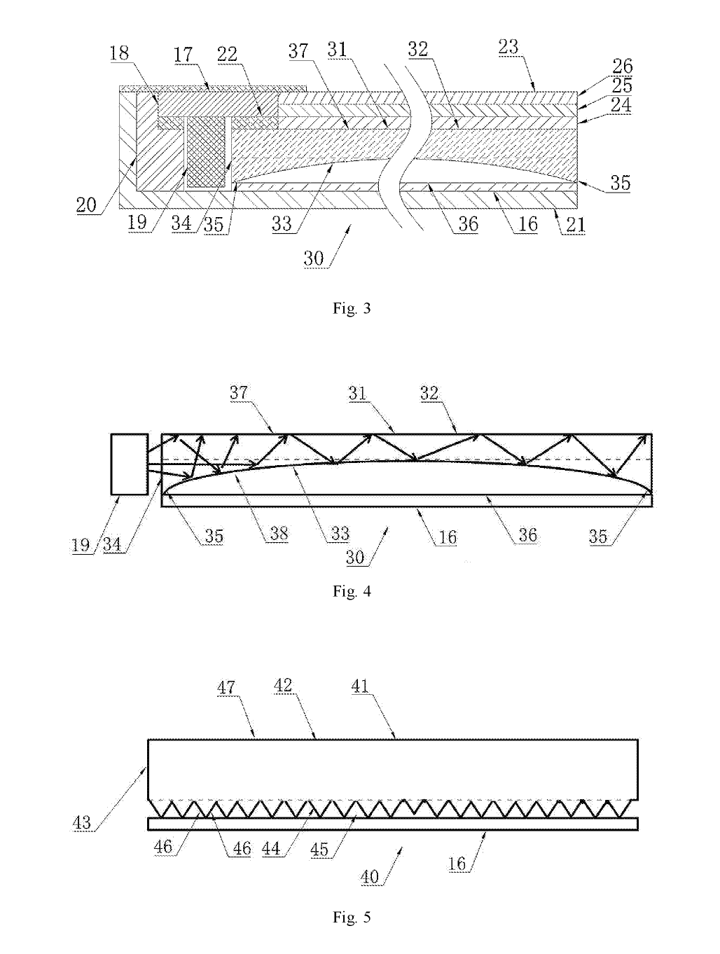

As shown in FIG. 3, a backlight module 30 comprises a light guide plate 31 which further comprises a body 37 and two projections 35. The body 37 is in the shape of a roughly rectangular plate, and a surface thereof is a light-emitting surface 32. A surface of the body 37 away from the light-emitting surface 32 is a back surface. The two projections 35 are both arranged on a surface of the body 37 of the light guide plate 31 away from the light-emitting surface 32 (i.e., on the back surface of the body 37), and project from the body 37 towards a direction opposite to the light-emitting surface 32. One of the side faces of the body 37 is used for entering of light. This side face of the body 37 faces the light-emitting elements 19. One of the two projections 35 is located close to this side face, and forms a light-incoming surface 34 of the light guide plate with its outer side and also this side face. The other projection 35 of the two projections 35 is arranged opposite to this side face.

Each of the two projections 35 is provided therein with a slope 38 facing the other projection 35. The two slopes are connected to each other to form a smooth arcuate surface 33 depressed towards the inside of the light guide plate 31.

The light guide plate 31 is usually made of a transparent material with a refractive index higher than that of air. The transparent material can be a transparent plastic, and is preferably polycarbonate, or polymethyl methacrylate.

An air layer 36 formed between the two projections 35 separates the light guide plate 31 from the reflecting sheet 16. The interface between the light guide plate 11 and the air layer has homogeneous reflectivity, and critical angle of total reflection on the interface is small enough, thereby rendering the light coming out of the light guide plate 31 more uniform, especially when the interface between the air layer 36 and the reflecting sheet 16 is the arcuate surface 33 depressed towards the inside of the light guide plate 31. As shown in FIG. 4, light irradiates on the arcuate surface 33 through the light-incoming surface 34. The arcuate surface 33 is depressed inward smoothly, leading to a better transmission path of light in the light guide plate 31. In this case, more light can be transmitted to a side of the light guide plate 31 away from the light-incoming surface 34, rendering the light emitted by the light-emitting surface 32 more uniform. In addition, due to an angle between the arcuate surface 33 and the light-incoming surface, more light perpendicular to the light-incoming surface 34 will be reflected by the arcuate surface 33 in an upward direction, or be refracted towards the reflecting sheet 16 when passing through the arcuated surface 33, and then be reflected by the reflecting sheet 16 in an upward direction. The light, instead of being absorbed in the light guide plate 31, exits from the light-emitting surface 32 of the light guide plate 31 after being refracted or reflected, thereby improving the utilization of the light and the brightness of the light-emitting surface.

Preferably, the arcuate surface 33 is formed by a translation movement of a circular arc or an elliptical arc along an extending direction of a straight line parallel to the light-incoming surface 34 and the light-emitting surface 32, in which case, the light reflected by the arcuate surface 33 will be distributed more homogenously in a direction parallel to the straight line when passing through the light-emitting surface 32.

Preferably, the two projections 35 each have a top end in the shape of a cuspidal edge. Thus the top ends of the two projections 35 are in line contact with the reflecting sheet 16, thereby reducing the contact area between the light guide plate 31 and the reflecting sheet 16, and thus reducing light leakage of the light guide plate 31.

Preferably, the light guide plate 31 is very smooth on each outer side faces and the light-emitting surface 32, except the arcuate surface 33 which is provided with a plurality of etched/printed reflecting lattice points. The reflecting lattice points are densely distributed on the arcuate surface 33, and are able to scatter the light irradiated thereon.

### Embodiment 3

The backlight module 40 in embodiment 3 differs from the backlight module 10 in embodiment 1 merely in structure of the light guide plate. For conciseness, the following description will focus mainly on the light guide plate 41 of the backlight module 40 in embodiment 3.

As shown in FIG. 5, a backlight module 40 comprises a light guide plate 41 which further comprises a body 47 and a plurality of projections 44. The body 47 is in the shape of roughly a plate, and a surface thereof is a light-emitting surface 42. The plurality of projections 44 is arranged on a surface of the body 47 away from the light-emitting surface 42, and extends from the body 47 along a direction opposite to the light-emitting surface 42. The plurality of projections 44 each are structured to be a prism, and are parallel to one another. A side face of the body 47 is used for entering of light, i.e., the side face is a light-incoming surface 43. Projections 44 extend parallel to the light-incoming surface 43 and the light-emitting surface 42. The projection has a cross section of a triangle. One cuspidal edge of the projections 44 faces a direction opposite to the light-emitting surface 42. The cross section of the projection has a gradually narrower width along a direction opposite to the light-emitting surface 42. In this case, a plurality of air layers 45 are formed between the light guide plate 41 and the projections 44.

The light guide plate 41 is usually made of a transparent material with a refractive index higher than that of air. The transparent material can be a transparent plastic, and is preferably polycarbonate, or polymethyl methacrylate. The light guide plate 41 is in the shape of a roughly rectangular plate, and a surface thereof is the light emitting surface 42. A surface away from the light emitting surface 42 is a back surface of the light guide plate 41. An outer side face of the body 47 is a light-incoming surface 43.

An air layer 45 formed between two neighboring projections 44 separates the light guide plate 41 from the reflecting 16. The interface between the light guide plate 41 and the air layers 45 has homogeneous reflectivity, and critical angle of total reflection on the interface is small enough, thereby rendering the light coming out of the light guide plate 41 more uniform, especially when each interface between the air layer 45 and the reflecting sheet 16 comprises two side faces 46 of the projections. Part of the light irradiating on the two side faces 46 forming an angle therebetween is reflected in sequence by the two side faces 46, and then exits towards the light-emitting surface 42. With such arrangement, the light does not have to irradiate on the reflecting sheet 16 through the air layer 45, and then be reflected by the reflecting sheet 16 to direct to the light-emitting surface 42, thereby avoiding absorption of light by defects in the air layer 45 or in the reflecting sheet 16, as well as escape of light in the reflecting sheet 16, and improving the utilization of light, and further, rendering the brightness of the light-emitting surface 42 higher. In addition, the top end of the projection is in line contact with the reflecting sheet 16, which decreases the contact area between the light guide plate 41 and the reflecting sheet 16, and thus reduces light leakage of the light guide plate 41.

Preferably, the cross section of each of the projection is an isosceles right triangle with a base parallel to the light-emitting surface 42. Such arrangement enables the maximized amount of the light reflected in sequence by the two sides 46 of the projections 44 and then exiting towards the light-emitting surface 42, thereby maximizing the utilization of light, and rendering the front end of the light-emitting surface brightest.

Preferably, the projections 44 each are a right prism. In this case, the light reflected by the projections 44 will be distributed more homogenously in a direction parallel to the projections 44 when passing through the light-emitting surface 42.

Preferably, the light guide plate 41 is very smooth on each side faces and the light-emitting surface 42, except the back surface which is provided with a plurality of etched/printed reflecting lattice points. The reflecting lattice points are densely distributed on the back surface, and are able to scatter the light irradiated thereon.

The above details are only descriptions on preferred embodiments of the present disclosure. Any improvements on the implementing forms or substitutions of the components thereof with equivalents can be made or done without departing from the scope of the present disclosure. It should be noted that as long as there is no structural conflict, any of the embodiments and any of the technical features thereof may be combined with one another. The present disclosure is not limited to any disclosed embodiment, and comprises all technical solutions falling within the scope of the present disclosure.

1. A light guide plate, comprising:
a plate-like body, a surface thereof being a light-emitting surface, and
a projection extending from a surface of the body away from the light-emitting surface along a direction opposite to the light-emitting surface.

2. The light guide plate according to claim 1, wherein provided are two projections which are located close to two opposite sides of the body respectively.

3. The light guide plate according to claim 2, wherein the two projections are the same in height.

4. The light guide plate according to claim 2, wherein the projections are in the shape of a strip, and extend parallel to side faces of the body which are close to the projections.

5. The light guide plate according to claim 3, wherein the projections are in the shape of a strip, and extend parallel to side faces of the body which are close to the projections.

6. The light guide plate according to claim 1, wherein the body has a side face for entering of light,
the light guide plate is provided with two projections, one being close to the side face, and the other being opposite to the side face, and
each projection is provided with a slope facing the other projection, and two slopes of the two projections are connected to form a arcuate surface depressed inwardly.

7. The light guide plate according to claim 6, wherein the arcuate surface is formed by a translation movement of a circular arc or an elliptical arc along an extending direction of a straight line parallel to the side face and the light-emitting surface.

8. The light guide plate according to claim 6, wherein the projections each have a top end in the shape of a cuspidal edge.

9. The light guide plate according to claim 7, wherein the projections each have a top end in the shape of a cuspidal edge.

10. The light guide plate according to claim 1, wherein the body has a side face for entering of light, and
the projections each are structured to be a prism extending in a direction parallel to the side face, and have a gradually narrower width along a direction opposite to the light-emitting surface.

11. The light guide plate according to claim 10, wherein the projections each have a cross section of a triangle.

12. The light guide plate according to claim 11, wherein the triangle is an isosceles right triangle, with a base parallel to the light-emitting surface.

13. The light guide plate according to claim 10, wherein the projections each are a right prism.

14. The light guide plate according to claim 11, wherein the projections each are a right prism.

15. The light guide plate according to claim 12, wherein the projections each are a right prism.

16. A liquid crystal display device, comprising a light guide plate,
wherein the light guide plate comprises:
a plate-like body, a surface thereof being a light-emitting surface, and
a projection extending from a surface of the body away from the light-emitting surface along a direction opposite to the light-emitting surface.
